(19) United States
(12) Patent Application Publication
(10) Pub. No.: US 2008/0107778 A1
(43) Pub. Date: May 8, 2008

(54) Structurally Layered Composition for Daily Diet

(76) Inventor: Wei-Kung Wang, Taipei (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/926,662

(22) Filed: Oct. 29, 2007

(30) Foreign Application Priority Data
Oct. 27, 2006 (TW) 095139960

(51) Int. Cl. A23L 1/302; A23P 1/08

(52) U.S. Cl. 426/72; 426/89

(57) ABSTRACT

A structurally layered composition for daily diet using fiber and oil as block to construct the effect of improving the body acidity, improving the oily skin, reducing the radicals, casting the body shape, keeping calcium in the body, controlling blood sugar and etc. Such composition may also work as the carrier for highly concentrated ingredients such as vitamins, minerals, drugs and so on. It will release different ingredients at different part of the digestive tract at different time. This design can control the time change of the specific ingredient in the blood as well as reduce the CO2 concentration in the body.

### FIELD OF THE INVENTION

The present invention is related to a composition in structural design for daily diet. Specifically, the present invention is related to a structurally layered composition for daily diet to reduce the amount of CO₂ or waste heat as producing ATP and extend the retention time in a digestive tract.

### BACKGROUND OF THE INVENTION

Food provides us nutrients on daily basis. The main components of the nutrients comprise functional proteins, oils and carbohydrate. Fibers or Cellulose is the most common supplements in daily diet and is good to health but provide no calorie and component for a human body.

It is known that delicately processed and constructed food can provide additional healthy benefit. For example, ingesting starch and sweet separately with protein is good for digestion. Meat and large amount of sweet or starch ingested at the same time can cause fermentation of the starch in the acid environment of the stomach that may cause stomach up set.

If we chow the starch in the mouth more thoroughly, the saliva will digest the starch or sweet first, then the meat that decent with the digested starch to the stomach will cause no trouble.

Upon metabolism, the nutrients in the human body provide ATP, i.e. adenosine triphosphate, which can be used as the essential energy, oil and carbohydrate will produce CO₂, H₂O and waste heat as well. The more efficient ATP production is, the less heat will be produced. For protein, it is first digested into amino acid, among which some of amino acid are used to make new proteins, and some are metabolized into NH₃, H₂O, CO₂ and waste heat. The NH₃ is processed and then secreted in the form of urea.

The CO₂ is produced within every cell of the body. If it is not properly removed, it may diffuse into the interstitial between cells, and reacts with H2O to produce H₂+CO₂<=>H⁺+HCO³⁻, and therefore reduces the osmotic pressure and attract more water molecules to accumulate them in the interstitial so as to cause edema, acidity of the body. H+ and HCO3− are radicals. It will damage cell, cause the loss of Ca and induce many chronicle diseases. To avoid these direct damage, body will wrap these acid with fat and deposit it at less harmful spots such as belly, double chins, swelling arm or thigh and so on, and thus change the body shape. There are much information throughout the website of Internet and published books about so called “Alkaline Food.” They promote alkaline food to reduce the fat deposition but totally have no idea where the acid is coming from.

To remove the acid, the sweat is another route; protecting the skin from burning, the oil is secreted with the acidified sweat (in the form of NH₄Cl). Therefore, it is the oil secreted with the acidified sweat that induces the oily skin that includes the head skin, it may thus induce hair loss.

To reduce the acidity of the body is a way to implement the body casting effect, that reduce the belly, double chins and etc., but not the breast or the buttock, it also reduce the chance of many chronicle diseases as declared by those advocates of the alkaline foods. The CO₂ which is not effectively removed in the human body is the source of acid and radicals. To prevent CO₂ retention in the body, we may increase the CO₂ exhalation enhanced through exercise, deeper breath or reduce the CO₂ production without effecting the ATP production.

The CO₂ reduction is to eat more oil. 8.4 ATP is produced in each CO₂ production when oil is metabolized. ATP production is reduced to 6.3 ATP for each CO₂ production when carbohydrate is metabolized, for protein metabolized only about 5 ATP is produced for each CO₂ production. While the ration of waste heat is 1:3:6 for oil, carbohydrate, and protein. To fight against heat waste, we need ingest more oil and less carbohydrate or protein. For the same amount of ATP production, the oil ingestion can reduce the CO₂ product by 33% compare to that from carbohydrate. Oil has 9 Kcal/g, which is more than twice that of carbohydrate and protein. As a result, we need to control the total calorie intake at the same time, and fiber that contains no calorie can be the supplement to make up the volume. Nevertheless, there is a shortcoming for such diet composition design. The fiber that contains no calorie will pass the digest tract very fast and make us feel hungry again and it induces more food ingestion.

Ingestion containing large proportion of oil will slow down the stomach juice secretion as well as movement that transfer food toward the small intestine, the body secretion there needs to break the oil chunk into small droplet to be adsorbed by the gut. Therefore, oil can extend the retention time of the food in the digestive tract. To reduce the CO₂ and waste heat production without effecting ATP production. To reduce the radicals, acid, reducing the calcium lost from bone, improving oily skin, controlling the oily head skin, to keep the hair and achieve the body casting and many other induced good effects, without putting on weight, this disclosure gives a new design and construction.

### SUMMARY OF THE INVENTION

According to the present invention, we provide a layered composition which wraps the fiber with oil in structure. If the layered composition is covered with oil, the digest tract will act itself it as treating total oil and thus extend its retention time in stomach. In fact, that in the oil of the layered composition according to the present invention is just fiber with no calorie. The layered composition is processed as if it were oil, while the calorie it contains is just a few percents of that if it were whole oil. The percents can be controlled by the thickness of the oil layer that covers the vegetable or other fibers. This design will extend the retention time that will give you the feeling of full, while the fiber in side can keep the total calorie contain low.

As a result, the present invention provides a layered composition for daily diet, comprising: an outer layer of oil; and an inner layer of fiber which is completely covered by said outer layer of oil, whereby said composition reduces the amount of CO₂ or waste heat as producing ATP and extends the retention time in a digestive tract.

The fiber can be the form of highly compressed one to increase its density. When soaked in the digestive juice, it will expend to enhance the feeling of full, while the ratio of oil content is further reduced.

Accordingly, we have therefore constructed a kind of diet composition that can reduce CO₂, radical, waste heat as well as control the carbohydrate intake to stabilized the blood sugar to be beneficial to the diabetes patients.

Making the designed food test better, at the out side of the oil, flavor ingredients such as chicken soup flavor, steak flavor and etc. This design of the layered composition for daily diet can be used to deliver substances such as nutrients, drug, and minerals into the body to replace the sugar coating or gel coating by combining or binding these ingredients into all kinds of different fibers, and then covering it with oil. This kind of fully natural product (e.g., a pill) according to the present invention will cause no allergy or any uncomfortable feeling to the digestive tract.

The structurally layered composition for daily diet according to the present invention may also accomplish the following functions: reducing the acidly of the body, improving the oily secretion of the skin, reducing the free radical in the body, controlling of the sugar level in the blood, controlling the release of specific ingredients in a specific place in the digestive track, and reducing the calcium loss.

### BRIEF DESCRIPTION OF THE DRAWING

FIG. 1 is vegetable, fruit, algae and etc. were treated then covered with a layer of oil; some flavor ingredients may be added at the outer surface of this pack. The size of 101 can be μm to tens of cm. The layer of oil 102 can be μm to mm in thickness.

FIG. 2 is a post-treatment fiber having a layer of oil coat first adding; if necessary, hydrophobic ingredients or designed ingredients are added first, and then pressed and covered a layer of oil.

FIG. 3A shows a product started from the product of FIG. 2, and it is covered with a layer of fiber and then another layer of oil. The ingredients in each layer can be same or different as needed.

FIG. 3B shows a product started from several products of FIG. 2, wherein each have same added ingredients or different ingredients, and each has its own fiber kind and density, oil kind and thickness.

### DETAILED DESCRIPTION OF THE INVENTION

The present invention will be more completely understood through the following detailed description, which should be read in conjunction with the attached drawings.

To develop the possible applications and products further according to the present invention, we can design the fiber and oil combination into multiple layers and multiple combinations, while selected ingredients can be designedly put in a specific padded fiber.

For example aspirin will cause excess gastric acid secretion in stomach that may cause ulcer. We may attach aspirin to the fiber then cover it with oil. This aspirin pill will not release aspirin in the stomach, it will be released in the intestine after the digestive juice there remove the oil coat; other ingredients that may hurt stomach can be treated in similar way.

Some bacterial are good to digestion in the intestine; however, they cannot tolerate the gastric acid and can hardly be admitted by oral means. This structurally layered composition in form of pill can be used as carrier for these good bacterial by protecting them in the fiber covered with oil, other acid sensitive material can be treated this way also.

Some medicine such as antibiotics, hormones or some hormone-inducing agent require extended hours with right concentration in the blood to be effective. They can be embedded in the fiber with different composition or density, cover with different oil with different composition or thickness to be constructed into different final size to control its releasing time. In a well-designed construction, we may release 20% of the embedded ingredient in every hour; one oral dose may keep the concentration of this medicine in the blood for 8-10 hours. If we can control the release at 10% per hour, one oral dose may keep the concentration up to 15-18 hours.

We may design the fiber and the oil layer into several different structures according to the present invention to fully control the pharmaco-kinetics to extend the therapeutic effects, reduce the side effect, oral doses and etc.

The products according to the present invention may be properly marked to instruct the users to select the most proper one to use. The CO₂ waste heat production for a molar ATP retention time in the digestive tissue may also be properly labeled. As the nutrients or medicines added, possible functions should also be properly labeled to let the user understand what product is best for the user.

A few examples from simple to more complicated one are disclosed.

### EXAMPLE 1

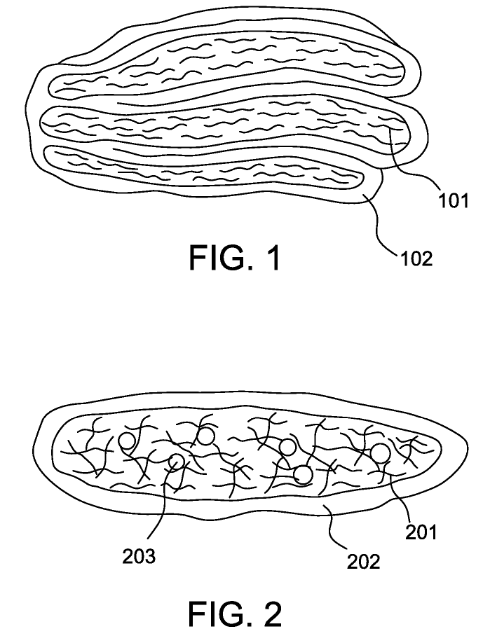

Any vegetable, fruit, algae etc., were depleted from other ingredient other than fiber or dehydrated or added with organism, mineral, vitamins etc. then the processed fiber may be compressed, to increase the density, to the designed volume, it was then covered with oil. The oil can be spread or immersed, evaporated on to the fibers. These processed is better done under N2 environment with no oxygen, no hydrogen. If the user has cholesterol problem, the oil can be cholesterol free. The final product is shown schematically in FIG. 1.

### EXAMPLE 2

High fiber vegetable, fruit or algae, such as konnyaku, agar or non-digestible fat-like compound made from sucrose are used as the source of edible fiber. It may be purified first to certain extent. The product is schematically drawn as FIG. 2. It is a post-treatment fiber 201 having a layer of oil coat 202; if necessary, hydrophobic ingredients or designed ingredients 203 are added first, and then pressed and covered a layer of oil. It can be embedded with nutrients, medicines or other ingredients first coated with oil, then nutrients or medicines especially the hydrophobic compounds may be added to the oil coating layer.

### EXAMPLE 3

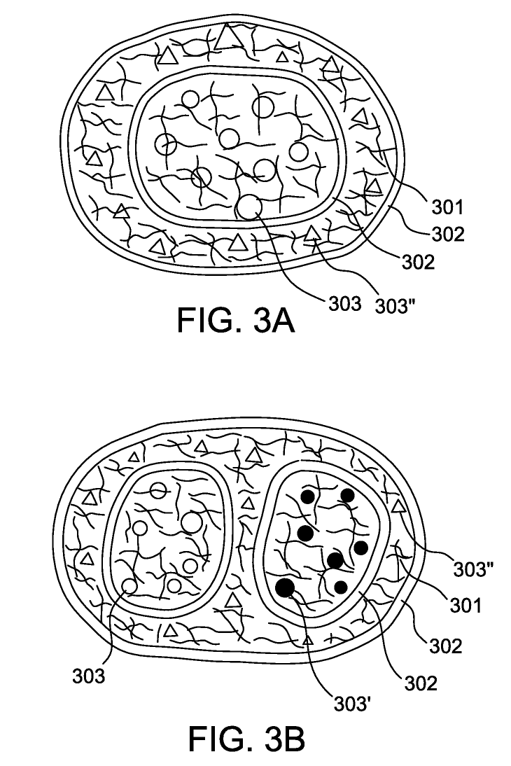

This fiber packing, ingredient embedding and oil coating can be repeated several times, in several different configuration as describes in FIGS. 3A and 3B as the possible combinations. Specifically, FIG. 3A is a product started from the product of FIG. 2. It was wrapped with fiber 301 and then another layer of oil 302. This process can be repeated several times. The ingredients in each layer can be same or different according to the requirements. FIG. 3B further shows a product started from several products of FIG. 2, wherein each have same added ingredients or different ingredients (303, 303′, 303″), and each has its own fiber kind and density, oil kind and thickness. Then it is covered with more fiber. This product so formed is looked as the products of FIG. 2 and repeat this process for a few times, so as to design a product (e.g., a pill) with a desired releasing time and concentration in the blood of each specific ingredient. The pill formed from this procedure uses all natural products without gel or sugar coating. This kind of pill will release internal ingredients in different layers at different designated time; therefore, we are capable of controlling several ingredients to release at different time as needed.

Although the embodiments disclosed above are discussed in the scope of providing solutions in response to a need for daily and healthy diet, one of ordinary skill in the art can easily adopt the same structurally layered composition for the providing of other type of purposes. Variations, modifications, and other implementations of what is described herein will occur to those of ordinary skill in the art without departing from the spirit and scope of the present invention as claimed. Accordingly, the present invention is to be defined not by the preceding illustrative description but instead by the spirit and scope of the following claims.

What is claimed is:

1. A layered composition for daily diet, comprising:
an outer layer of oil; and
an inner layer of fiber which is completely covered by said outer layer of oil,
whereby said composition reduces the amount of CO2 or waste heat as producing ATP and extends the retention time in a digestive tract.

2. The structurally layered composition for daily diet of claim 1, wherein said inner layer of fiber comprises cellulose.

3. The structurally layered composition for daily diet of claim 3, wherein said inner layer of fiber is purified.

4. The structurally layered composition for daily diet of claim 3, wherein said inner layer of fiber is dehydrated.

5. The structurally layered composition for daily diet of claim 3, further comprising ingredient selected from the group consisting of vitamin, minerals, medicine and flavorful ingredient.

6. The structurally layered composition for daily diet of claim 5, wherein said flavorful ingredient is contained in a surface of said outer layer of oil.

7. The structurally layered composition for daily diet of claim 5, wherein said inner layer of fiber or outer layer of oil contains are individually different in kind and thickness.

8. The structurally layered composition for daily diet of claim 3, wherein said fiber comprises different kinds of fibers with different density.

9. The structurally layered composition for daily diet of claim 8, wherein said outer layer of oil and said inner layer of fiber further comprise different ingredients and constructed in various structures.

10. The structurally layered composition for daily diet of claim 1, which the composition does not contain cholesterol.

11. The structurally layered composition for daily diet of claim 1, wherein the composition is made into a product labeled with the function of ATP or CO2 produced in each unit,
waste heat produced in each unit, or the retention time in the digestive tract.

12. The structurally layered composition for daily diet of claim 11, wherein said product is labeled with ingredients and functions.

13. The structurally layered composition for daily diet of claim 12, said functions comprises casting a human body.
